(19) United States
(12) Patent Application Publication
(10) Pub. No.: US 2024/0187778 A1
(43) Pub. Date: Jun. 6, 2024

(54) HEARING DEVICE WEAR STATE DETECTION METHOD AND APPARATUS, AND HEARING DEVICE AND MEDIUM

(71) Applicant: GOERTEK INC., Weifang, Shandong (CN)

(72) Inventors: Jingcong ZHAO, Weifang, Shandong (CN); Yujie ZHOU, Weifang, Shandong (CN)

(21) Appl. No.: 18/553,608

(22) PCT Filed: Jun. 28, 2021
(86) PCT No.: PCT/CN2021/102746

§ 371 Date: Oct. 2, 2023

(30) Foreign Application Priority Data
Apr. 2, 2021 (CN) 202110364944.7

(51) Int. Cl. H04R 1/10; H04R 29/00

(52) U.S. Cl. CPC H04R 1/1041; H04R 1/1083; H04R 29/00; H04R 2460/01

(57) ABSTRACT

The present disclosure discloses wear state of a hearing device detection method and apparatus, and a device and a storage medium. The method comprises: a feedback microphone obtaining a transient pulse signal; and according to a feature parameter of the transient pulse signal and the previous wear state of the noise-cancelling hearing device, determining the current wear state of a noise-cancelling hearing device. A feedback microphone in a noise-cancelling hearing device itself that is used to cancel noise is used to detect the wear state of the hearing device. In this way, upon determining the wear state of the noise-cancelling hearing device, no additional sensor is required for the noise-cancelling hearing device, and instead, the feedback microphone of the noise-cancelling hearing device itself can be used to accurately detect the wear state of the hearing device in a timely manner.

### CROSS REFERENCE TO RELATED APPLICATIONS

This application claims the priority to the Chinese patent application No. 202110364944.7, entitled “HEARING DEVICE WEAR STATE DETECTION METHOD AND APPARATUS, AND HEARING DEVICE AND MEDIUM” submitted to China National Intellectual Property Administration on Apr. 2, 2021, the entire contents of which are incorporated herein by reference.

### TECHNICAL FIELD

The present disclosure relates to the field of detection of hearing device wear state, particularly, to a hearing device wear state detection method and apparatus, and hearing device and storage medium.

### BACKGROUND

Recently, with the popularization of noise-cancelling hearing device technology, its share in the overall hearing device market in the e-commerce market has been greatly increased, and it has achieved high user satisfaction. Due to the small volume of the hearing devices, there is not enough space to accommodate large-capacity batteries, so how to improve the battery life of the hearing devices has become a problem for hearing device design manufacturers. In order to prolong the battery life of the hearing device as much as possible and to improve the user experience, most hearing devices have added a wearing detection function. When it is detected that the hearing device is taken off, some functions of the hearing device will be automatically turned off to save power.

In the related art, hearing device wear state monitoring is mainly performed by additionally provided infrared sensors. This detection method requires additional infrared sensors on the hearing devices, which increases the design complexity and cost.

### SUMMARY

The main purpose of the present disclosure is to provide a hearing device wear state detection method and apparatus, and hearing device and storage medium, aiming to solve the technical problem of higher design complexity and higher cost of detecting the wear state of the noise-cancelling hearing device.

In order to achieve the above purpose, the present disclosure provides a method for detecting a wear state of a hearing device, which is implemented by a noise-cancelling hearing device, the noise-cancelling hearing device includes a feedback microphone, and the method for detecting the wear state of the hearing device includes: obtaining a transient pulse signal through the feedback microphone; and determining, according to a characteristic parameter of the transient pulse signal and the previous wear state of the noise-cancelling hearing device, a current wear state of the noise-cancelling hearing device, wherein the wear state of the noise-cancelling hearing device includes a wearing state and a non-wearing state.

Optionally, determining, according to the characteristic parameter of the transient pulse signal and the previous wear state of the noise-cancelling hearing device, a current wear state of the noise-cancelling hearing device includes: determining, according to the characteristic parameter of the transient pulse signal, whether a state change event is detected, wherein the state change event includes a putting on event and a taking off event; If a state change event is detected, determining that the current wear state of the noise-cancelling hearing device is different from the previous wear state of the noise-cancelling hearing device; and if no state change event is detected, determining that the current wear state of the noise-cancelling hearing device is the same as the previous wear state of the noise-cancelling hearing device.

Optionally, determining, according to the characteristic parameter of the transient pulse signal, whether a state change event is detected includes: if the maximum amplitude of the transient pulse signal is smaller than a preset amplitude threshold, determining that no state change event is detected.

Optionally, determining, according to the characteristic parameter of the transient pulse signal, whether a state change event is detected includes: if the maximum amplitude of the transient pulse signal is greater than or equal to a preset amplitude threshold, transforming the transient pulse signal into frequency-domain to obtain a frequency-domain signal spectrum; and determining whether a state change event is detected according to whether abscissa and ordinate values of the frequency-domain signal spectrum in a preset frequency band are linearly correlated.

Optionally, determining whether a state change event is detected according to whether abscissa and ordinate values of the frequency-domain signal spectrum in a preset frequency band are linearly correlated includes: if the abscissa and ordinate values of the frequency-domain signal spectrum in the preset frequency band are not linearly correlated, determining that no state change event is detected; if the abscissa and ordinate values of the frequency-domain signal spectrum in the preset frequency band are linearly correlated, obtaining an initial vibration direction of the transient pulse signal and the previous wear state of the noise-cancelling hearing device; and determining whether a state change event is detected according to the initial vibration direction and the previous wear state of the noise-cancelling hearing device.

Optionally, determining whether a state change event is detected according to the initial vibration direction and the previous wear state of the noise-cancelling hearing device includes: if the initial vibration direction is a negative direction and the previous wear state of the noise-cancelling hearing device is the non-wearing state, or, if the initial vibration direction is a positive direction and the previous wear state of the noise-cancelling hearing device is the wearing state, determining that no state change event is detected; and if the initial vibration direction is the negative direction and the previous wear state of the noise-cancelling hearing device is the wearing state, or, if the initial vibration direction is the positive direction and the previous wear state of the noise-cancelling hearing device is the non-wearing state, determining that a state change event is detected.

Optionally, the noise-cancelling hearing device further includes an acceleration sensor, and before obtaining the transient pulse signal through the feedback microphone, the method further includes: detecting, by the acceleration sensor, an acceleration of the noise-cancelling hearing device; and if the acceleration is greater than a preset acceleration threshold, obtaining the transient pulse signal through the feedback microphone.

Furthermore, in order to achieve the above purpose, the present disclosure further provides an apparatus for detecting a wear state of a hearing device, wherein the device for detecting the wear state of the hearing device includes: a signal obtaining module configured to obtain a transient pulse signal through a feedback microphone; and a state determination module configured to determine, according to the characteristic parameter of the transient pulse signal and the previous wear state of the noise-cancelling hearing device, a current wear state of the noise-cancelling hearing device, wherein the wear state of the noise-cancelling hearing device includes a wearing state and a non-wearing state.

Furthermore, in order to achieve the above purpose, the present disclosure further provides a hearing device comprising a feedback microphone, a memory, a processor, and a program for detecting a wear state of the hearing device stored on the memory and operable on the processor, wherein the program for detecting the wear state of the hearing device, when executed by the processor, implements steps of the method for detecting a wear state of the hearing device as described above.

Furthermore, in order to achieve the above purpose, the present disclosure further provides a storage medium having stored thereon a program for detecting a wear state of a hearing device, wherein the program for detecting the wear state of the hearing device, when executed by a processor, implements steps of the method for detecting a wear state of the hearing device as described above.

The present disclosure obtains a transient pulse signal through the feedback microphone, and determines a current wear state of the noise-cancelling hearing device according to the characteristic parameter of the transient pulse signal and the previous wear state of the noise-cancelling hearing device. The detection of the wear state of the hearing device is achieved through the in-built feedback microphone of the noise-cancelling hearing device for noise-cancelling. In this way, the wear state of the noise-cancelling hearing device, when being determined, may be accurately detected in a timely manner by the in-built feedback microphone of the noise-cancelling hearing device without an additional sensor for the noise-cancelling hearing device. Therefore, it is unnecessary to improve the hardware of the noise-cancelling hearing device, which reduces the design complexity and the cost of the hearing device.

### BRIEF DESCRIPTION OF DRAWINGS

FIG. 1 is a schematic structural diagram of the device hardware operating environment of the hearing device according to an embodiment of the present disclosure.

FIG. 2 is a schematic flowchart of the method for detecting the wear state of the hearing device according to a first embodiment of the present disclosure.

FIG. 3 is a schematic diagram of the transient pulse signal received by the noise-cancelling hearing device according to the present disclosure.

FIG. 4 is a schematic diagram of a frequency-domain signal spectrum corresponding to the transient pulse signal received by the noise-cancelling hearing device of the present disclosure.

The achievements, functional features and advantages of the present disclosure will be further described in conjunction with the embodiments and with reference to the accompanying drawings.

### DETAILED DESCRIPTIONS

It should be understood that the specific embodiments described herein are only used to explain the present disclosure, not to limit the present disclosure.

It would be understood that, in the related art, hearing device wear state monitoring may be implemented by adding a gravity sensor or an infrared sensor. This detection method has to be provided with an additional gravity sensor or infrared sensor to the hearing device, which increases the design complexity and the cost.

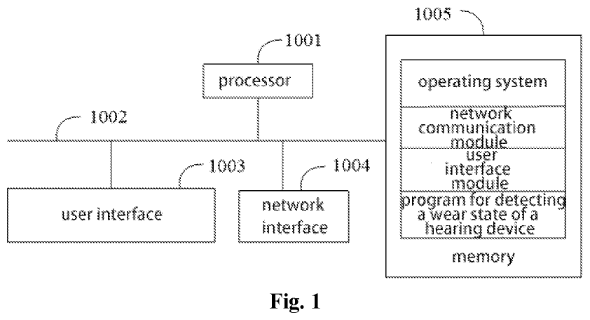

Accordingly, the present disclosure provides a hearing device. Referring to FIG. 1, FIG. 1 is a schematic structural diagram of the device hardware operating environment of the hearing device according to an embodiment of the present disclosure.

As illustrated in FIG. 1, the hearing device may include: a processor 1001, such as a CPU, a communication bus 1002, a user interface 1003, a network interface 1004, and a memory 1005. Here, the communication bus 1002 is used to implement connection and communication between these components. The user interface 1003 may include a display screen (Display), and an input unit, such as a keyboard. Optionally, the user interface 1003 may also include a standard wired interface and a wireless interface. Optionally, the network interface 1004 may include a standard wired interface and a wireless interface (such as a WI-FI interface). The memory 1005 can be a high-speed RAM memory, or a non-transistor memory (non-volatile memory), such as a magnetic disk memory. Optionally, the memory 1005 may also be a separate storage device independent of the aforementioned processor 1001.

Those skilled in the art can understand that the hardware structure of the hearing device illustrated in FIG. 1 should not be construed as limitations to the hearing device of the present disclosure, and may include more or less components than illustrated in the drawings, or combining a part of the components, or arranged differently.

As illustrated in FIG. 1, the memory 1005, which is a storage medium, may stores an operating system, a network communication module, a user interface module, and a program for detecting the wear state of the hearing device. Here, the operating system is a program for managing and controlling the hearing device and software resources, and supporting the operation of the network communication module, the user interface module, the program for detecting the wear state of the hearing device, and other programs or software. The network communication module is configured to manage and control the network interface 1004. The user interface module is configured to manage and control the user interface 1003.

In the hearing device hardware structure as illustrated in FIG. 1, the network interface 1004 may be configured to connect to the background server to perform data communication with the background server. The user interface 1003 may be configured to connect to the client to perform data communication from the client. The processor 1001 may operate the program for detecting the wear state of the hearing device stored in the memory 1005, and perform the following operations: obtaining a transient pulse signal through the feedback microphone; and determining, according to a characteristic parameter of the transient pulse signal and the previous wear state of the noise-cancelling hearing device, a current wear state of the noise-cancelling hearing device, wherein the wear state of the noise-cancelling hearing device includes a wearing state and a non-wearing state.

Furthermore, determining, according to the characteristic parameter of the transient pulse signal and the previous wear state of the noise-cancelling hearing device, a current wear state of the noise-cancelling hearing device includes: determining, according to the characteristic parameter of the transient pulse signal, whether a state change event is detected, wherein the state change event includes a putting on event and a taking off event; if a state change event is detected, determining that the current wear state of the noise-cancelling hearing device is different from the previous wear state of the noise-cancelling hearing device; and if no state change event is detected, determining that the current wear state of the noise-cancelling hearing device is the same as the previous wear state of the noise-cancelling hearing device.

Furthermore, determining, according to the characteristic parameter of the transient pulse signal, whether a state change event is detected includes: if the maximum amplitude of the transient is smaller than a preset amplitude threshold, determining that no state change event is detected.

Furthermore, determining, according to the characteristic parameter of the transient pulse signal, whether a state change event is detected includes: if the maximum amplitude of the transient pulse signal is greater than or equal to a preset amplitude threshold, transforming the transient pulse signal into frequency-domain to obtain a frequency-domain signal spectrum; and determining whether a state change event is detected according to whether abscissa and ordinate values of the frequency-domain signal spectrum in a preset frequency band are linearly correlated.

Furthermore, determining whether a state change event is detected according to whether abscissa and ordinate values of the frequency-domain signal spectrum in a preset frequency band are linearly correlated includes: if the abscissa and ordinate values of the frequency-domain signal spectrum in the preset frequency band are not linearly correlated, determining that no state change event is detected; if the abscissa and ordinate values of the frequency-domain signal spectrum in the preset frequency band are linearly correlated, obtaining an initial vibration direction of the transient pulse signal and the previous wear state of the noise-cancelling hearing device; and determining whether a state change event is detected according to the initial vibration direction and the previous wear state of the noise-cancelling hearing device.

Furthermore, determining whether a state change event is detected according to the initial vibration direction and the previous wear state of the noise-cancelling hearing device includes: if the initial vibration direction is a negative direction and the previous wear state of the noise-cancelling hearing device is the non-wearing state, or, if the initial vibration direction is a positive direction and the previous wear state of the noise-cancelling hearing device is the wearing state, determining that no state change event is detected; and if the initial vibration direction is the negative direction and the previous wear state of the noise-cancelling hearing device is the wearing state, or, if the initial vibration direction is the positive direction and the previous wear state of the noise-cancelling hearing device is the non-wearing state, determining that a state change event is detected.

Furthermore, the noise-cancelling hearing device further includes an acceleration sensor, and before obtaining the transient pulse signal through the feedback microphone, the method further includes: detecting, by the acceleration sensor, an acceleration of the noise-cancelling hearing device; and if the acceleration is greater than a preset acceleration threshold, obtaining the transient pulse signal through the feedback microphone.

The specific implementation of the hearing device according to the present disclosure is basically the same as the following embodiments of the method for detecting the wear state of the hearing device, and will not be duplicated.

The present disclosure also provides a method for detecting the wear state of the hearing device based on the aforementioned hearing device.

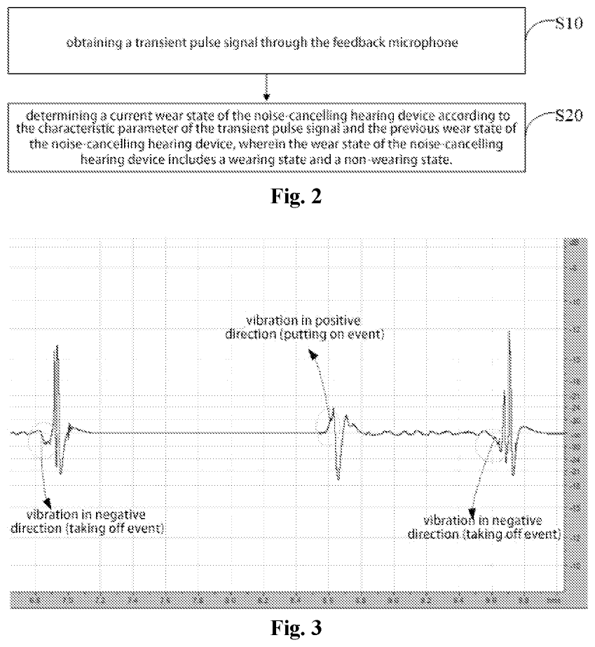

Referring to FIG. 2, FIG. 2 is a schematic flowchart of the method for detecting the wear state of the hearing device according to a first embodiment of the present disclosure.

The embodiment of the present disclosure provides an embodiment of the method for detecting the wear state of the hearing device. It should be understood that although the logic sequence is illustrated in the flow chart, in some cases, the illustrated or described steps may be executed in a different sequence from that illustrated here.

In each embodiment of the method for detecting the wear state of the hearing device, the executing subject may be the hearing device, the controller, or the hearing device control system. For ease of description, the controller is described as the executing subject in this embodiment.

The method for detecting the wear state of the hearing device is implemented by the noise-cancelling hearing device, the noise-cancelling hearing device includes a feedback microphone, and method for detecting the wear state of the hearing device includes the following step.

Step S10, obtaining a transient pulse signal through the feedback microphone.

In the related art, hearing device wear state monitoring is mainly performed by an additional provided gravity sensor or an infrared sensor. This detection method needs to add an additional gravity sensor or infrared sensor to the hearing device, which increases the design complexity and the cost.

In order to solve the problem of high design complexity and high cost of the detection of the wear state of the noise-cancelling hearing device in the related art, a method for detecting the wear state of the hearing devices is proposed in the embodiment of the present disclosure, which aims to achieve the detection of the wear state of the hearing device is achieved through the in-built feedback microphone of the noise-cancelling hearing device for noise-cancelling. In this way, the wear state of the noise-cancelling hearing device, when being determined, may be accurately detected in a timely manner by the in-built feedback microphone of the noise-cancelling hearing device without an additional sensor for the noise-cancelling hearing device. Therefore, it is unnecessary to improve the hardware of the noise-cancelling hearing device, which reduces the design complexity and the cost of the hearing device.

The method for detecting the wear state of the hearing device in this embodiment is suitable for a noise-cancelling hearing device. Generally, the noise-cancelling hearing device having an active noise-cancelling function includes a feedback microphone, wherein the feedback microphone is arranged inside the hearing device. the feedback microphone is located in the closed cavity formed by the hearing device and the ear when a user puts on the hearing device. The microphone can be understood as a transducer that converts acoustic energy into electrical energy. A diaphragm is disposed inside the microphone, and external sound is transmitted to the diaphragm through the air, causing the diaphragm to vibrate. Such mechanical vibration may be transduced into a voltage signal by the transducer.

This embodiment considers that the relative displacement generated when the user puts on or takes off the hearing device may change the volume of the closed cavity formed by the hearing device and the ear to squeeze the air in the cavity so as to further squeeze the diaphragm of the feedback microphone, so that the feedback microphone receive a transient pulse signal similar to that illustrated in FIG. 3, which reflects the change in the signal over time and thus is also called a time-domain pulse signal. The abscissa of the transient pulse signal spectrum is time, and the ordinate is amplitude. It can be seen from the figure that when an event of putting on or taking off the hearing device occurs, the amplitude of the signal received by the feedback microphone is significantly greater than that when an event of putting on or taking off the hearing device does not occur.

Step S20, determining, according to the characteristic parameter of the transient pulse signal and the previous wear state of the noise-cancelling hearing device, a current wear state of the noise-cancelling hearing device, wherein the wear state of the noise-cancelling hearing device includes a wearing state and a non-wearing state.

In this embodiment, after the transient pulse signal is obtained, the transient pulse signal is analyzed to determine the characteristic parameter of the transient pulse signal, and then the current wear state of the noise-cancelling hearing device is determined according to the characteristic parameter and the previous wear state of the noise-cancelling hearing device. Here, the characteristic parameter of the transient pulse signal includes at least one of the maximum amplitude of the transient pulse signal, the initial vibration direction, or the linear correlation in the corresponding frequency-domain signal spectrum.

In addition, the wear state of the noise-cancelling hearing device includes the wearing state and the non-wearing state. The noise-cancelling hearing device may update and store the wear state according to whether the hearing devices are in a wearing state or a non-wearing state, so that the noise-cancelling hearing device determines the current wear state of the noise-cancelling hearing device according to the characteristic parameter of the transient pulse signal as well as the most recently stored wear state (i.e., the previous wear state), and updates the stored wear state after the current wear state is determined.

In this embodiment, the transient pulse signal is obtained through the feedback microphone, and the current wear state of the noise-cancelling hearing device is determined according to the characteristic parameter of the transient pulse signal and the previous wear state of the noise-cancelling hearing device. In this embodiment, the detection of the wear state of the hearing device is achieved through the in-built feedback microphone of the noise-cancelling hearing device for noise-cancelling. In this way, the wear state of the noise-cancelling hearing device, when being determined, may be accurately detected in a timely manner by the in-built feedback microphone of the noise-cancelling hearing device without an additional sensor for the noise-cancelling hearing device. Therefore, it is unnecessary to improve the hardware of the noise-cancelling hearing device, which reduces the design complexity and the cost of the hearing device.

Further, a second embodiment of the method for detecting the wear state of the hearing device according to the present disclosure is proposed, wherein the aforementioned step S20 specifically includes the following steps.

Step a1, determining, according to the characteristic parameter of the transient pulse signal, whether a state change event is detected, wherein the state change event includes a putting on event and a taking off event.

Step a2, if a state change event is detected, determining that the current wear state of the noise-cancelling hearing device is different from the previous wear state of the noise-cancelling hearing device.

Step a3, if no state change event is detected, determining that the current wear state of the noise-cancelling hearing device is the same as the previous wear state of the noise-cancelling hearing device.

In this embodiment, the switching of the wear state of the hearing device inevitably experiences a state change event. That is, only when a state change event occurs, can the hearing device be switched from one wear state to another wear state. For example, when the hearing device is in the wearing state, only after taking-off event can it be switched to the non-wearing state, and when the hearing device is in the non-wearing state, only after the putting on event can it be switched to the wearing state. Here, the putting on event refers to the action of putting the hearing device on the ear, and the taking-off event refers to the action of removing the hearing device from the ear. The wearing state refers to the state that the hearing device is being worn in-ear, on-ear, or over-ear, and the non-wearing state refers to the state that the hearing device is not being worn in-ear, on-ear, or over-ear.

Therefore, the key to detecting the wear state of the hearing device is to detect the state change event, so the current wear state of the hearing device can be determined according to the previous wear state of the hearing device and whether a state change event has occurred. If no state change event is detected, it means that the wear state of the hearing device has not changed, and the current wear state of the noise-cancelling hearing device is the same as the previous wear state of the noise-cancelling hearing device. If a state change event is detected, it means that the wear state of the hearing device has changed and the current wear state of the noise-cancelling hearing device is different from the previous wear state of the noise-cancelling hearing device. Since the wear state includes either the wearing state or the non-wearing state, the changed wear state of the hearing device can be uniquely determined based on the previous wear state if the wear state of the hearing device has changed.

In this embodiment, the state detection of the hearing device is changed into the state change event detection, and then is combined with the state change event and the previous wear state to determine the current wear state, thereby avoiding the limitation and one-sidedness of determining the wear state of the hearing device only based on the current state parameters of the hearing device and improving the accuracy of the current wear state detection.

Further, the aforementioned step a1 includes the following step.

Step b1, if the maximum amplitude of the transient pulse signal is smaller than a preset amplitude threshold, determining that no state change event is detected.

In this embodiment, the preset amplitude threshold is the minimum amplitude when one reaction state change event occurs, which is determined by the developer in advance according to a large number of pulse signals of putting on events, taking-off events, and other hearing device usage events. Here, the preset amplitude threshold may be any value between −25 dBFS to −15 dBFS, such as −20 dBFS, and the pulse signal whose amplitude is greater than or equal to the threshold can be considered to be generated by the state change event whereas the pulse signal whose amplitude is less than the threshold can be considered to be generated by usage event (e.g., pressing the hearing device to make the hearing device fit more tightly with the ear when the hearing device is in the wearing state) which is not the state change event.

Therefore, if the maximum amplitude of the transient pulse signal is less than the preset amplitude threshold, it means that the relative displacement between the hearing device and the ear has not changed, or the relative displacement between the hearing device and the ear is small, and the vibration amplitude of the diaphragm of the feedback microphone generated by the change in volume of the formed cavity formed is small, and thus it is determined that no state change event is detected, and then it can be determined that the current wear state of the hearing device is the same as the previous wear state of the noise-cancelling hearing device. If the previous wear state is the wearing state, then the current wear state is also the wearing state, and if the previous wear state is the non-wearing state, the current wear state is also the non-wearing state.

Further, the aforementioned step a1 also includes the following steps.

Step c1, if the maximum amplitude of the transient pulse signal is greater than or equal to a preset amplitude threshold, transforming the transient pulse signal into frequency-domain to obtain a frequency-domain signal spectrum.

Step c2, determining whether a state change event is detected according to whether abscissa and ordinate values of the frequency-domain signal spectrum in a preset frequency band are linearly correlated.

In this embodiment, if the maximum amplitude of the transient pulse signal is greater than or equal to the preset amplitude threshold, it means that the diaphragm of the feedback microphone is subjected to a strong squeeze force but it is not yet possible to determine whether the squeeze is caused by a state change event because high-frequency noise from the outside may also generate a transient pulse signal whose maximum amplitude is greater than or equal to the preset amplitude threshold. Therefore, if it is directly determined that a state change event is detected when the maximum amplitude of the transient pulse signal is greater than or equal to the preset amplitude, it may generate a large number of false detections. In order to reduce the misjudgment rate of the wear state, when the maximum amplitude of the transient pulse signal is greater than or equal to the preset amplitude threshold, the transient pulse signal may be subjected to frequency-domain transformation (e.g., by fast Fourier transform) to obtain a frequency-domain signal spectrum, and the frequency-domain signal spectrum is further analyzed. Here, the frequency-domain is a coordinate system for describing the characteristics of the signal in terms of frequency. The abscissa of the frequency-domain signal spectrum is the frequency, and the ordinate thereof is the amplitude of the frequency signal. The spectrum describes the frequency configuration of the signal and the relationship between the frequency and the amplitude of the frequency signal.

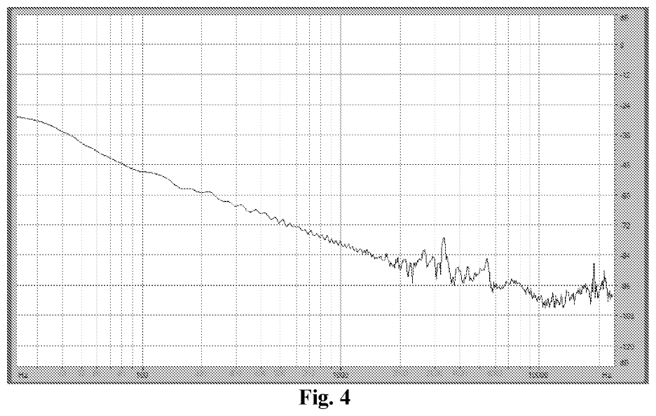

The frequency-domain signal spectrum when a state change event occurs can refer to FIG. 4. With a large number of experiments, the applicants found that when a state change event occurs, the abscissa and ordinate values of the frequency-domain signal spectrum in the preset frequency band are linearly correlated. Here, the preset frequency band is generally a frequency band below 1000 Hz, and developers can set a specific range of the preset frequency band according to needs, which is not specifically limited in this embodiment. For example, if the preset frequency band is 200 Hz to 400 Hz, and the values of the abscissa and ordinate are linearly correlated in the frequency range of 100 Hz to 400 Hz in FIG. 4, it can be determined that the transient pulse signal corresponding to FIG. 4 is tended to be generated by the state change events and further analysis and determination are required. If the values of the abscissa and ordinate in the 100 Hz to 400 Hz frequency band in FIG. 4 are not linearly correlated, it can be directly determined that no state change event is detected.

Further, the above step c2 includes the following steps.

Step d1, if the abscissa and ordinate values of the frequency-domain signal spectrum in the preset frequency band are not linearly correlated, determining that no state change event is detected.

Step d2, if the abscissa and ordinate values of the frequency-domain signal spectrum in the preset frequency band are linearly correlated, obtaining an initial vibration direction of the transient pulse signal and the previous wear state of the noise-cancelling hearing device.

Step d3, determining whether a state change event is detected according to the initial vibration direction and the previous wear state of the noise-cancelling hearing device.

In this embodiment, if the values of the abscissa and ordinate of the frequency-domain signal spectrum in the preset frequency band are not linearly correlated, it may be directly determined that no state change event is detected. And, if the values of the abscissa and ordinate of the frequency-domain signal spectrum in the preset frequency band are linearly correlated, the tendency to detect a state change event is relatively high but it is not yet possible to determine whether the squeeze is generated by a state change event, because the frequency-domain signal spectrum corresponding to other usage events that are not state change events (e.g., strongly press the hearing device when the hearing device is in the wearing state) also has a possibility that the values of the abscissa and the ordinate in the preset frequency band are linearly correlated. In order to exclude this possibility, in this embodiment, when the values of the abscissa and ordinate of the spectrum in the preset frequency band are linearly correlated, the initial vibration direction of the transient pulse signal and the previous wear state of the noise-cancelling hearing device may be further analyzed to determine whether a state change event is detected.

Further, the above step d3 includes the following steps.

Step e1, if the initial vibration direction is a negative direction and the previous wear state of the noise-cancelling hearing device is the non-wearing state, or, if the initial vibration direction is a positive direction and the previous wear state of the noise-cancelling hearing device is the wearing state, determining that no state change event is detected.

Step e2, if the initial vibration direction is the negative direction and the previous wear state of the noise-cancelling hearing device is the wearing state, or, if the initial vibration direction is the positive direction and the previous wear state of the noise-cancelling hearing device is the non-wearing state, determining that a state change event is detected.

When the hearing device is in the wearing state, that is, when the putting on event occurs, the closed cavity formed by the hearing device and the ear canal instantly becomes smaller, forming a positive pressure, and the feedback microphone is subjected to the positive impact of the airflow, and thus, the waveform of the transient pulse signal starts to move toward the positive direction. When the hearing devices are taken off, that is, when the event of taking off occurs, the closed cavity formed by the hearing devices and the ear canal becomes larger instantly, forming a negative pressure, and the impact of the airflow on the feedback microphone is negative, and the starting direction of the waveform is negative direction.

When determining whether a state change event occurs, it needs to be determined by combining the initial vibration direction and the previous wear state of the noise-cancelling hearing device. If the initial vibration direction is negative direction and the previous wear state of the noise-cancelling hearing device is the non-wearing state, indicating that no putting on event occurs, or, if the initial vibration direction is positive direction and the previous wear state of the noise-cancelling hearing device is the wearing state, indicating that no taking off event occurs, then it is determined that no state change event is detected.

If the initial vibration direction is negative direction and the previous wear state of the noise-cancelling hearing device is the wearing state, indicating that a taking-off event occurs, or, if the initial vibration direction is positive direction and the previous wear state of the noise-cancelling hearing device is the non-wearing state, indicating that a putting on event occurs, then it is determined that a state change event is detected.

In this embodiment, whether a state change event occurs is determined by considering the parameters of four dimensions including the maximum amplitude of the transient pulse signal, the initial vibration direction, the linear correlation in the corresponding frequency-domain signal spectrum, and the previous wear state, so as to determine the current wear state of the hearing device, which can avoid the problem of high misjudgment rate when determining the wear state based on single-dimensional parameter, and improves the accuracy of wear state detection.

Further, in an implementation scenario, the noise-cancelling hearing device may also include an acceleration sensor, and before the aforementioned step S10, the method further includes the following steps.

Step a1, detecting, by the acceleration sensor, an acceleration of the noise-cancelling hearing device.

Step a2, if the acceleration is greater than a preset acceleration threshold, performing Step S10.

In order to reduce the power consumption of the feedback microphone and further prolong the battery life of the noise-cancelling hearing device, in this embodiment, the feedback microphone is kept in a normally-off state, and an acceleration sensor is provided for the noise-cancelling hearing device, and the acceleration of the noise-cancelling hearing device is detected by the acceleration sensor. When the acceleration of the hearing device is detected to be greater than the preset acceleration threshold, it indicates that the hearing device may have experienced moving actions, such as, being taken out of the hearing device box, moved, and being worn in-ear, on-ear, or over-ear (i.e., a putting on event occurs) or being removed from the ear (i.e., a taking-off event occurs), but it is impossible to determine which of the above-mentioned actions the hearing device has experienced. Therefore, it is necessary to turn on the feedback microphone for a preset period of time to obtain the transient pulse signal within the preset period of time through the feedback microphone and thus to further determine the current wear state of the noise-cancelling hearing device according to the transient pulse signal. After the preset period of time elapses, the feedback microphone is turned off. Here, the preset period of time can be set by the developer according to needs, for example, it can be any value between 2 seconds to 4 seconds, such as 2.5 seconds.

It can be understood that, if the detected acceleration of the noise-cancelling hearing device is less than the preset acceleration threshold, it is considered that no state change event is detected, and the feedback microphone may continue to be in the normally-off state.

Of course, if an instruction to enable the noise-cancelling function is received, the feedback microphone is normally turned on for noise-cancelling.

In this embodiment, the acceleration sensor detects the acceleration of the noise-cancelling hearing device, and only when the acceleration is greater than a preset threshold, is the feedback microphone turned on to obtain the transient pulse signal, which can reduce the power consumption of the feedback microphone.

In addition, an embodiment of the present disclosure also proposes a device for detecting the wear state of the hearing device, and the device for detecting the wear state of the hearing device includes: a signal obtaining module configured to obtain a transient pulse signal through a feedback microphone; and a state determination module configured to determine, according to a characteristic parameter of the transient pulse signal and the previous wear state of the noise-cancelling hearing device, a current wear state of the noise-cancelling hearing device, wherein the wear state of the noise-cancelling hearing device includes a wearing state and a non-wearing state.

The specific implementation of the device for detecting the wear state of the hearing device of the present disclosure is basically the same as the above embodiments of the method for detecting the wear state of the hearing device, and will not be duplicated here.

In addition, an embodiment of the present disclosure also proposes a storage medium.

The storage medium has stored thereon a program for detecting a wear state of a hearing device, wherein the program for detecting the wear state of the hearing device, when executed by a processor, implements steps of the method for detecting a wear state of the hearing device as described above.

The specific implementation of the storage medium of the present disclosure is basically the same as the above-mentioned embodiments of the method for detecting the wear state of the hearing device, and will not be duplicated here.

Although the embodiments of the present disclosure have been described above in conjunction with the accompanying drawings, the present disclosure is not limited to the above-mentioned embodiments. These embodiments are only illustrative and not restrictive. Those of ordinary skill in the art may also make various modifications under the teaching of this application, without departing from the spirit of this application and the scope of the claims, any equivalent structure or equivalent process modifications made using the description and drawings of this application, or direct or indirect applications to other related technical fields, all fall in the protection scope of this application.

1. A method for detecting a wear state of a hearing device, which is implemented by a noise-cancelling hearing device, the noise-cancelling hearing device comprises a feedback microphone, and the method for detecting a wear state of the hearing device comprises:
obtaining a transient pulse signal through the feedback microphone; and
determining, according to a characteristic parameter of the transient pulse signal and a previous wear state of the noise-cancelling hearing device, a current wear state of the noise-cancelling hearing device,
wherein the wear state of the noise-cancelling hearing device comprises a wearing state and a non-wearing state.

2. The method for detecting a wear state of the hearing device according to claim 1, wherein determining, according to a characteristic parameter of the transient pulse signal and the previous wear state of the noise-cancelling hearing device, a current wear state of the noise-cancelling hearing device comprises:
determining, according to the characteristic parameter of the transient pulse signal, whether a state change event is detected, wherein the state change event comprises a putting on event and a taking off event;
if a state change event is detected, determining that the current wear state of the noise-cancelling hearing device is different from the previous wear state of the noise-cancelling hearing device; and
if no state change event is detected, determining that the current wear state of the noise-cancelling hearing device is the same as the previous wear state of the noise-cancelling hearing device.

3. The method for detecting the hearing device wear state according to claim 2, wherein determining, according to the characteristic parameter of the transient pulse signal, whether a state change event is detected comprises:
if the maximum amplitude of the transient pulse signal is smaller than a preset amplitude threshold, determining that no state change event is detected.

4. The method for detecting the hearing device wear state according to claim 2, wherein determining, according to the characteristic parameter of the transient pulse signal, whether a state change event is detected comprises:
if the maximum amplitude of the transient pulse signal is greater than or equal to a preset amplitude threshold, transforming the transient pulse signal into frequency-domain to obtain a frequency-domain signal spectrum; and
determining whether a state change event is detected according to whether abscissa and ordinate values of the frequency-domain signal spectrum in a preset frequency band are linearly correlated.

5. The method for detecting the hearing device wear state according to claim 4, wherein determining whether a state change event is detected according to whether abscissa and ordinate values of the frequency-domain signal spectrum in a preset frequency band are linearly correlated comprises:
if the abscissa and ordinate values of the frequency-domain signal spectrum in the preset frequency band are not linearly correlated, determining that no state change event is detected;
if the abscissa and ordinate values of the frequency-domain signal spectrum in the preset frequency band are linearly correlated, obtaining an initial vibration direction of the transient pulse signal and the previous wear state of the noise-cancelling hearing device; and
determining whether a state change event is detected according to the initial vibration direction and the previous wear state of the noise-cancelling hearing device.

6. The method for detecting a wear state of the hearing device according to claim 5, wherein determining whether a state change event is detected according to the initial vibration direction and the previous wear state of the noise-cancelling hearing device comprises:
if the initial vibration direction is a negative direction and the previous wear state of the noise-cancelling hearing device is the non-wearing state, or, if the initial vibration direction is a positive direction and the previous wear state of the noise-cancelling hearing device is the wearing state, determining that no state change event is detected; and
if the initial vibration direction is the negative direction and the previous wear state of the noise-cancelling hearing device is the wearing state, or, if the initial vibration direction is the positive direction and the previous wear state of the noise-cancelling hearing device is the non-wearing state, determining that a state change event is detected.

7. The method for detecting a wear state of the hearing device according to claim 1, wherein the noise-cancelling hearing device further comprises an acceleration sensor, and
wherein, before obtaining the transient pulse signal through the feedback microphone, the method further comprises:
detecting, by the acceleration sensor, an acceleration of the noise-cancelling hearing device; and
if the acceleration is greater than a preset acceleration threshold, obtaining the transient pulse signal through the feedback microphone.

8. An apparatus for detecting a wear state of a hearing device, wherein the device for detecting a wear state of the hearing device comprises:
a signal obtaining module configured to obtain a transient pulse signal through a feedback microphone; and
a state determination module configured to determine, according to a characteristic parameter of the transient pulse signal and a previous wear state of the noise-cancelling hearing device, a current wear state of the noise-cancelling hearing device, wherein the wear state of the noise-cancelling hearing device comprises a wearing state and a non-wearing state.

9. A hearing device comprising a feedback microphone, a memory, a processor, and a program for detecting a wear state of the hearing device stored on the memory and operable on the processor, wherein the program for detecting a wear state of the hearing device, when executed by the processor, implements steps of the method for detecting a wear state of the hearing device according to claim 1.

10. A storage medium having stored thereon a program for detecting a wear state of a hearing device, wherein the program for detecting a wear state of the hearing device, when executed by a processor, implements steps of the method for detecting a wear state of the hearing device according to claim 1.
